(19) United States
(12) Patent Application Publication
(10) Pub. No.: US 2026/0128515 A1
(43) Pub. Date: May 7, 2026

(54) COMMUNICATIONS DEVICE WITH CONDUCTIVE SINUSOIDAL LENS ELEMENT AND RELATED ANTENNAS AND METHODS

(71) Applicant: Eagle Technology, LLC, Melbourne, FL (US)

(72) Inventor: Francis E. Parsche, Palm Bay, FL (US)

(21) Appl. No.: 19/364,536

(22) Filed: Oct. 21, 2025

Related U.S. Application Data
(63) Continuation-in-part of application No. 18/788,698, filed on Jul. 30, 2024.

(51) Int. Cl. H01Q 3/46; H01Q 9/04; H01Q 13/02; H01Q 19/30

(52) U.S. Cl. CPC H01Q 3/46; H01Q 9/0407; H01Q 13/02; H01Q 19/30

(57) ABSTRACT

A communications device may include an RF device, an RF antenna coupled to the RF device, and an RF lens adjacent to the RF antenna. The RF lens may have a dielectric substrate, and a conductive sinusoidal trace carried by the dielectric substrate. The at least one conductive sinusoidal trace may include a plurality of conductive sinusoidal traces, such as four, for example. The dielectric substrate may have a cylinder-shape, or a cone-shape.

### RELATED APPLICATION

This application is based upon prior filed copending application Ser. No. 18/788,698 filed Jul. 30, 2024, the entire subject matter of which is incorporated herein by reference in its entirety.

### TECHNICAL FIELD

The present disclosure relates to the field of communications, and, more particularly, to a wireless communications device and related methods.

### BACKGROUND

Although the field of antennas is approximately 130 years old, antenna types and their designs may remain artisan in nature. Radiation pattern requirements, in and of themselves, may not suggest all possible antenna shapes that are useful. For example, Fourier Transform techniques may refer to a radiation pattern shape and a planar antenna aperture current distribution. Nonetheless, the Fourier Transform may not easily define an elongate end fire antenna.

During a golden age for antenna design, many of the Euclidian geometries were implemented in metal and used as antennas with useful results. For example, these approaches may comprise: the line-based wire dipole, the circular loop, the conical horn, and the parabolic reflector antenna, etc. The Euclidian shapes may offer optimizations of the shortest distance between two points for the line dipole. Also, these shapes may offer maximum radiation resistance for length, most area enclosed for least circumference for circular loops and circular patches, and maximum directivity for aperture area.

Reflectors and lenses may be used to operate on antenna radiation. In the metal reflector, a feed antenna is provided, and a shaped conductive surface directs the feed energy. Reflector limitations include feed energy spillover, surface accuracy needs, and back reflections into the feed. In the dielectric lens, a nonconductive material may be shaped to be either concave or convex, and interposed with the wave. Dielectric lens limitations include excessive weight, material loss, and internal reflections.

In some approaches, plasmonic lenses may operate at subwavelength sizes and below existing diffraction limits. One example is disclosed in U.S. Pat. No. 7,888,663 to Zhou. To form the plasmonic lens, a series of slits is made in thin metal film. Negative permittivity and superfocusing are accomplished. Ordinary metals cannot, however, form a plasmonic lens at radio frequencies as metals cannot support the required surface plasmon movements (e.g., oscillations in electron density). In a copper plasmonic lens, the required operating frequency is above the familiar red color of copper metal. For radio frequency, antennas, this technology may await a radio frequency solid plasma material.

Elongate antennas may be desirable for Earth satellites as planar broadside firing antennas may not fit within a limited satellite size and area. An elongate antenna of high directivity and gain is provided by a cascade of multiple dipoles known as the Yagi-Uda Antenna. (“Beam Transmission Of Short Waves”, Proceedings of the Institute Of Radio Engineers, 1928, Volume 16, Issue 6, pages 716-740). This reference referred to the many directors as a “wave canal”. These director systems may be known today as artificial lenses. A Yagi-Uda antenna may be narrow in bandwidth, which limits its application, and the beam may be asymmetric.

In an existing approach, an antenna providing circular polarization is an axial mode wire helix antenna. An example is disclosed in “Helical Beam Antennas For Wide-Band Applications”, John D. Kraus, Proceedings Of The Institute Of Radio Engineers, 36, pp 1236-1242, October 1948. An improvement to the wire axial mode helix is found in U.S. Pat. No. 5,892,480 to Killen, assigned to the present application's assignee. This approach for a directional antenna comprises a helix-shaped antenna. Although this antenna is directional, the helix-shaped antenna may not provide dual polarizations and modifications for linear polarization may be less than desirable.

Referring briefly to FIGS. 1A-1B, another existing approach discloses a helix-shaped antenna 100. This antenna 100 includes a helix-shaped conductor 101, and a conductive plane 102 coupled to the helix-shaped conductor. Diagram 160 shows gain performance for the antenna 100. The provided gain has a non-flat profile, which is less desirable in radio design.

### SUMMARY

Generally, a communications device may comprise a radio frequency (RF) device, an RF antenna coupled to the RF device, and an RF lens adjacent to the RF antenna. The RF lens may comprise a dielectric substrate, and at least one conductive sinusoidal trace carried by the dielectric substrate.

In some embodiments, the at least one conductive sinusoidal trace may comprise a plurality of conductive sinusoidal traces. The plurality of conductive sinusoidal traces may comprise four conductive sinusoidal traces equally-sized and arranged about the dielectric substrate. Also, adjacent ones of the plurality of conductive sinusoidal traces may be nested together. For example, the dielectric substrate may have one of a cylinder-shape and a cone-shape. The RF antenna may comprise one of a patch antenna, a horn antenna, and a Yagi-Uda antenna.

The RF antenna may have an operating wavelength. For example, the dielectric substrate of the RF lens may have a diameter between 0.3 and 0.5 of the operating wavelength, and the dielectric substrate may have a height between 0.5 and 1 of the operating wavelength. The at least one conductive sinusoidal trace may define a wave period between 0.1 and 0.3 of the operating wavelength. The at least one conductive sinusoidal trace may have a shape based upon (d/4)sin(2πf)+0.8(d/4)sin(2πf), f being an operating frequency of the RF antenna, and d being a diameter of the dielectric substrate. The at least one conductive sinusoidal trace may provide a wave polarizer function.

Another aspect is directed to a method for making a communications device. The method comprises coupling an RF antenna to an RF device, and positioning an RF lens adjacent to the RF antenna. The RF lens may comprise a dielectric substrate, and at least one conductive sinusoidal trace carried by the dielectric substrate.

### BRIEF DESCRIPTION OF THE DRAWINGS

FIG. 1A is a perspective view of an antenna, according to the prior art.

FIG. 1B is a diagram of gain in the antenna of FIG. 1A.

FIG. 2A is a perspective view of a communications device, according to a first example embodiment of the present disclosure.

FIG. 2B is a top down plan view of a circular cylindrical antenna from the communications device of FIG. 2A.

FIG. 2C is an enlarged perspective view of the circular cylindrical antenna from the communications device of FIG. 2A.

FIG. 2D is a schematic diagram of a conductive feed for the circular cylindrical antenna from the communications device of FIG. 2A.

FIG. 3 is a top down plan view of dielectric substrate before being formed into the circular cylindrical antenna from the communications device of FIG. 2A.

FIG. 4 is a schematic diagram of a multiple polarization feed network in the communications device of FIG. 2A.

FIG. 5 is a radiation pattern diagram for the communications device of FIG. 2A.

FIG. 6 is a diagram of realized gain versus frequency for the communications device of FIG. 2A.

FIG. 7 is a diagram of VSWR for the communications device of FIG. 2A.

FIG. 8 is a Smith Chart diagram for the communications device of FIG. 2A at different operating frequencies.

FIG. 9 is a side view of a communications device, according to a second example embodiment of the present disclosure.

FIG. 10 is a side view of a communications device, according to a third example embodiment of the present disclosure.

FIG. 11 is a side view of a communications device, according to a fourth example embodiment of the present disclosure.

FIG. 12A is a perspective view of a communications device, according to a fifth example embodiment of the present disclosure.

FIG. 12B is a side view of the circular cylindrical antenna from the communications device of FIG. 12A.

FIG. 13 is a side view depicting a variable pitch circular cylindrical antenna, according to a sixth example embodiment of the present disclosure.

FIG. 14A-14D are side views of slot, panel and fill variations of the elements used in the communications device, according to the present disclosure.

FIGS. 15A-15H depict polygonal and fractal embodiments of the elements used in the communications device, according to the present disclosure.

FIG. 16A shows an electrical excitation for the communications device of FIG. 2A producing an axial null radiation pattern.

FIG. 16B is a diagram of the axial null radiation pattern provided by the communications device of FIG. 16A.

FIGS. 17A-17B are perspective and exploded views, respectively, of a communications device, according to another example embodiment of the present disclosure.

FIG. 18 is a perspective view of a communications device, according to yet another example embodiment of the present disclosure.

FIG. 19 is a perspective view of a communications device, according to another example embodiment of the present disclosure.

FIG. 20 is a perspective view of a communications device, according to still another example embodiment of the present disclosure.

FIG. 21 is a perspective view of a communications device, according to an additional example embodiment of the present disclosure.

FIG. 22 is a perspective view of a communications device, according to another example embodiment of the present disclosure.

FIG. 23 is a perspective view of a communications device, according to still another example embodiment of the present disclosure.

FIG. 24 is a diagram of the axial null radiation pattern provided by the communications device of FIG. 17A-17B.

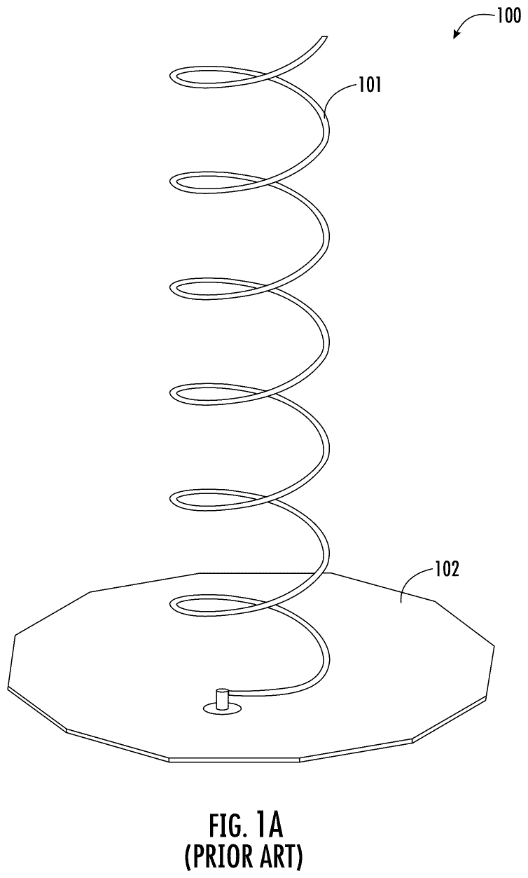

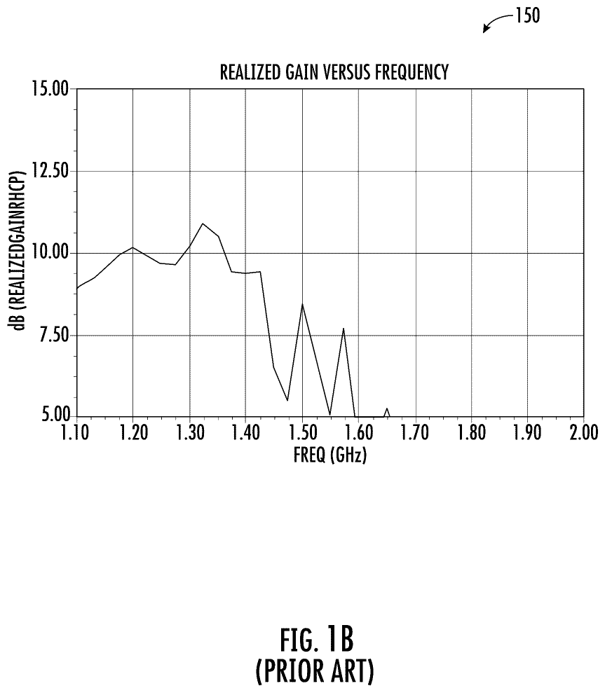

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

For the prior art antenna 100, this approach is an axial mode helix antenna. Because of this, helix antennas may be polarization limited. In particular, the antenna 100 may provide limited circular polarization only. For multiple polarization applications, these may need multiple helix antennas, one for each polarization, increasing size and weight. Also, linear polarization may not be possible. A new approach to end fire antenna radiation and multiple polarizations may be needed.

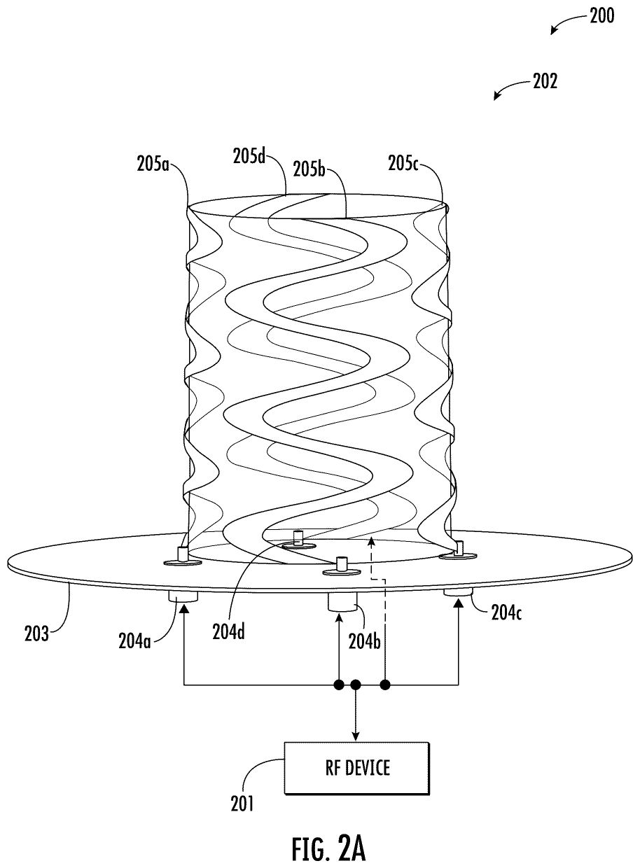

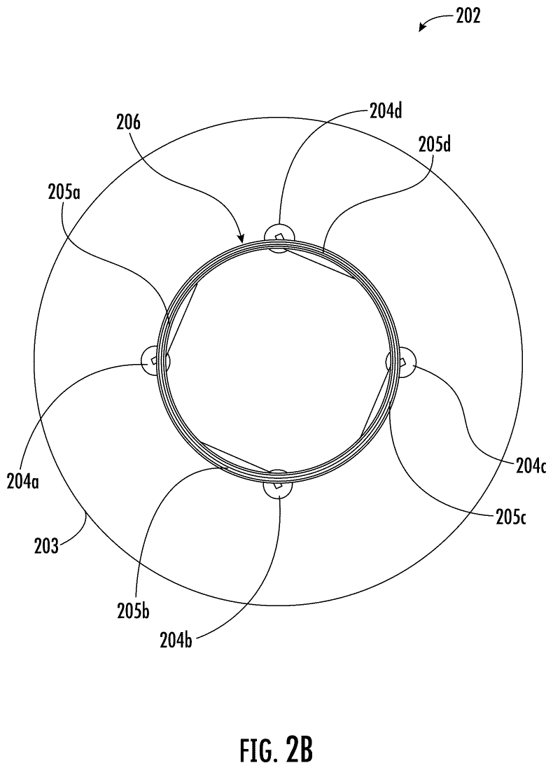

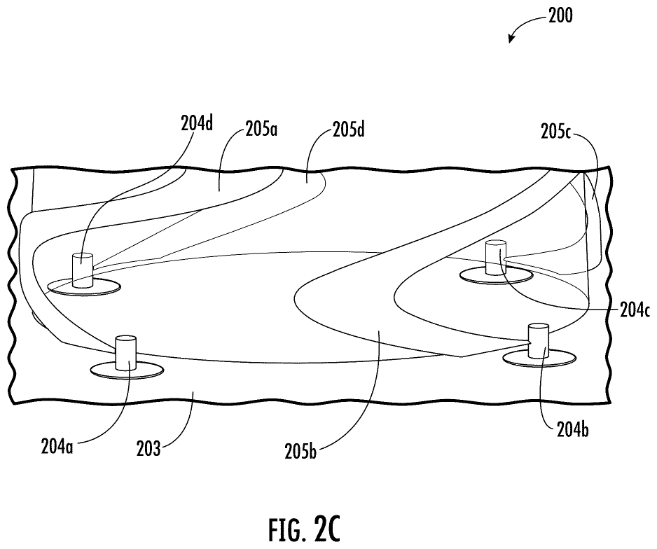

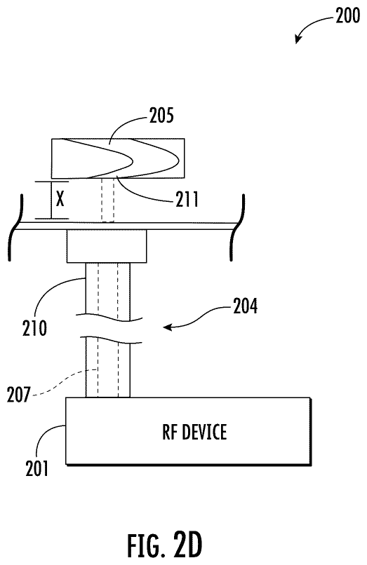

Referring now to FIGS. 2A-2C, a communications device 200 according to the present disclosure is now described. The communications device 200 also provides an approach to overcome the potential drawbacks of existing approaches.

The communications device 200 includes an RF device 201, and a circular cylindrical antenna 202 coupled to the RF device. The circular cylindrical antenna 202 illustratively includes a conductive ground plane 203, and a plurality of conductive feeds 204a-204d associated with the conductive ground plane. In particular, the plurality of conductive feeds 204a-204d may extend through respective passageways in the conductive ground plane 203.

The circular cylindrical antenna 202 illustratively comprises a plurality of conductive sinusoidal elements 205a-205d coupled respectively to the plurality of conductive feeds 204a-204d and extending outwardly from the conductive ground plane 203. For example, each of the conductive ground plane 203, the plurality of conductive feeds 204a-204d, and the plurality of conductive sinusoidal elements 205a-205d may comprise one or more of copper, aluminum, silver, and gold. It is understood that conductive sinusoidal elements 205a-205d could also constitute cosine conductive elements 205a-205d, or sinusoidal elements shifted in phase structurally to start at any point in the structures cyclic motion.

In particular, the plurality of conductive sinusoidal elements 205a-205d extend upward and away from the conductive ground plane 203 at a transverse angle (e.g., the substantially perpendicular angle in the illustration, ±10° of 90°). As perhaps best seen in FIGS. 2A-2B, the plurality of conductive sinusoidal elements 205a-205d extends along a circular cylinder 206. As will be appreciated, the sides of the circular cylinder 206 are substantially perpendicular to the conductive ground plane 203, and define a constant diameter for the circular cylinder as it progresses distally and away from the conductive ground plane 203.

The conductive ground plane 203 illustratively has a width greater than a diameter of the circular cylinder 206. Also, the conductive ground plane 203 is illustratively circle-shaped, but may take other shapes, such as an oval, or polygonal shape. Further, in some embodiments, the conductive ground plane 203 may be integrated into the body of a mobile platform.

As shown in the illustrated embodiment, the plurality of conductive sinusoidal elements 205a-205d comprises four conductive sinusoidal elements equally-sized and arranged about the circular cylinder 206 (i.e., radially spaced apart at 90° to provide an orthogonal arrangement). Also, adjacent ones of the plurality of conductive sinusoidal elements 205a-205d may be nested together closely for compact size or they may be spaced further apart around the circular cylinder 206 circumference. Spaced apart conductive sinusoidal elements 205a-205d may provide a circular polarization with a lower axial ratio. FIGS. 2A-2C may show a nested together embodiment.

Each of the plurality of conductive sinusoidal elements 205a-205d has, prior to wrapping onto the cylinder, a shape defined by a sine function. In some embodiments, the sine function may comprise the integral region between (d/4)sin(2πf) and 0.8(d/4)sin(2πf) and this may cause the plurality of conductive sinusoidal elements 205a-205d to have a nonconstant trace width widening at peaks in the structural cycle. In other embodiments the plurality of conductive sinusoidal elements 205a-205d may be a sine shaped trace of constant width or a wire. Where f is an operating frequency of the circular cylindrical antenna 202, and where d is a diameter of the circular cylinder 206. In other words, the structural amplitude of the plurality of conductive sinusoidal elements 205a-205d is directly related to the operating radio frequency. The height (i.e., the thickness across the surface of the circular cylinder 206) of each of the amplitude of the plurality of conductive sinusoidal elements 205a-205d is defined by the sine function noted hereinabove. In some embodiments, the plurality of conductive sinusoidal elements 205a-205d may constitute wire-like conductive sinusoidal elements 205a-205d; therefore, this embodiment may comprise four sinusoidal wires extending upwards from the conductive ground plane 203.

As will be appreciated by one skilled in the art, first, second, third, and fourth signals fed into the plurality of conductive feeds 204a-204d may, for circular polarization, have an excitation of equal amplitude and a progressive phasing of 360/n, where n=the number of conductive feeds. For n=4, the phase advance is 90° for each element and with an equal amplitude or power. For example, looking at an n=4 circular cylindrical antenna 202 from behind the conductive ground plane 203, and in the direction radiation, the excitation phase progresses in clockwise fashion with the plurality of conductive feeds 204a-204d having phases of 0°, −90°, −180°, −270° to provide right hand circular polarization (RHCP).

Referring now additionally to FIG. 2D, for drawing clarity, only one of the plurality of conductive feeds 204 is shown. It should be appreciated that the other conductive feeds 204a-204d have similar structure. The conductive feed 204 illustratively includes a coaxial cable feed coupling the RF device 201 and the circular cylindrical antenna 202. The coaxial cable feed illustratively comprises an inner conductor 207 and an outer conductor 210 surrounding the inner conductor. The outer conductor 210 is coupled to the conductive ground plane 203. The inner conductor 207 extends through the conductive ground plane 203 and is coupled to a proximal end 211 of the respective conductive sinusoidal element 205. The proximal end 211 of the at conductive sinusoidal element 205 defines a gap x with adjacent portions of the conductive ground plane 203.

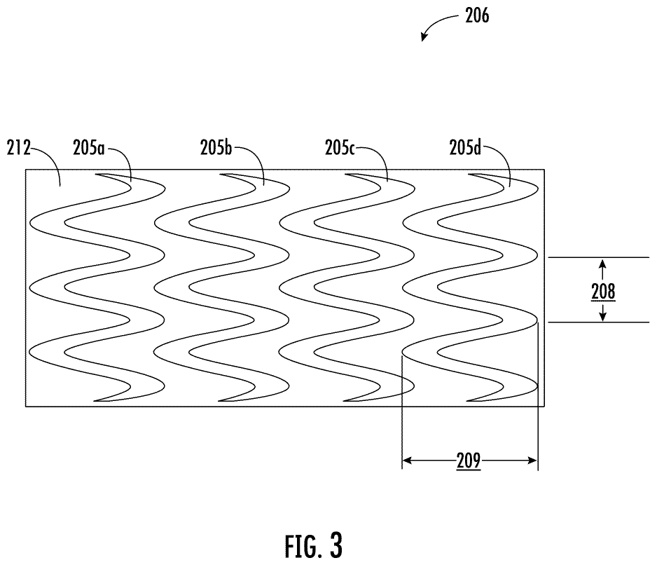

Referring additionally to FIG. 3, with regards to spatial dimensions of the circular cylindrical antenna 202, these are defined by the operating wavelength of the communications device 200. The spatial dimensions may vary over a large range depending on frequency, desired realized gain, desired beamwidth, and the desired antenna radiation pattern. For 4 spaced apart conductive sinusoidal elements 205a-205d, a useful circular cylinder 206 diameter may be between 0.3 and 0.6 of the operating wavelength. The circular cylinder 206 may have a height between 0.5 and 20 or more operating wavelengths depending on realized gain requirements, and the structures of each of the plurality of conductive sinusoidal elements 205a-205d may define a wave period or structural period 208 as shown in FIG. 3 between about 0.05 and 0.3 of the operating wavelength.

Referring now additionally to FIG. 3, the circular cylindrical antenna 202 illustratively comprises a circular cylindrical dielectric substrate 212, and each of the plurality of conductive sinusoidal elements 205a-205d comprises a conductive trace on the circular cylinder dielectric substrate. For example, the circular cylindrical dielectric substrate 212 may comprise a flexible circuit board layer. Each of the conductive traces may have a thickness of at least two skin depths for the operating wavelength. In particular, the dielectric substrate is shown here before being formed into a cylinder. As will be appreciated, the conductive traces may be formed on the dielectric substrate using typical techniques, such as plating and etching. In other embodiments, the plurality of conductive sinusoidal elements 205a-205d may be formed via an additive manufacturing process. Also, in some embodiments, the circular cylindrical dielectric substrate 212 may be swapped out for a dielectric cylinder base, and the conductive traces are formed on the dielectric cylinder base, for example, using additive manufacturing. Here, the structural period 208 is understood as the number of back and forth cycles per unit length in a conductive sinusoidal element 205a-205d. Although a constant structural period 208 is depicted, the structural period 208 may vary along the length of the conductive sinusoidal element 205a-205d in some embodiments, such as to adjust radio wave speed to maximize directivity. Each of the plurality of conductive sinusoidal elements 205a-205d has a structural amplitude 209 that defines a width of each conductive sinusoidal element 205a-205d. While a constant structural amplitude 209 is depicted in FIG. 3, some embodiments may have a varying or nonconstant structural amplitude 209 along the length of one or more of the plurality of conductive sinusoidal elements 205a-205d, such as for increased bandwidth.

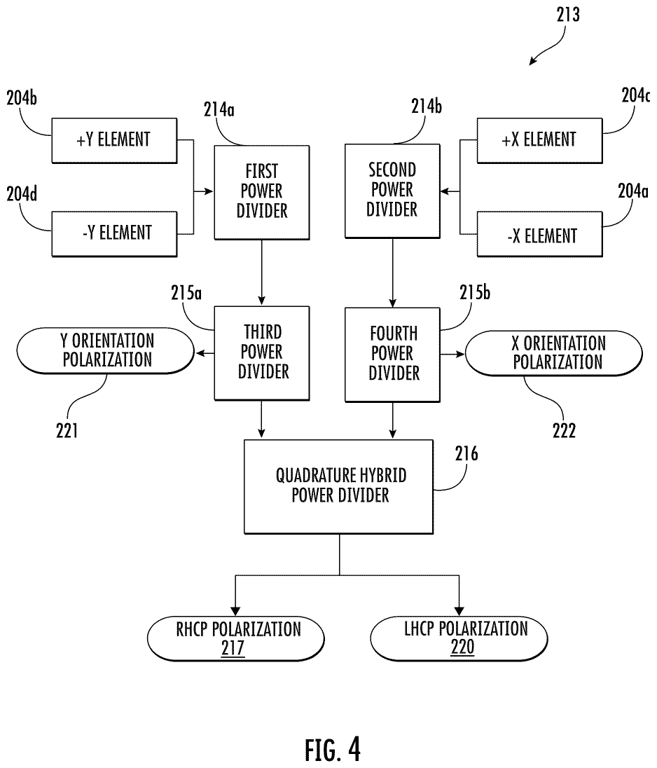

Referring now additionally to FIG. 4, the communications device 200 may comprise a feed network 213 coupled between the RF device 201 and the circular cylindrical antenna 202. The feed network 213 illustratively comprises the plurality of conductive feeds 204a-204d, first and second power dividers 214a-214b (e.g., 180° power dividers) coupled downstream from the plurality of conductive feeds, third and fourth power dividers 216a-216b (e.g., power dividers or switches) coupled downstream from the first and second power divides, and a quadrature (90°) hybrid power divider 216 coupled downstream from third and fourth power dividers. In this exemplary configuration of the feed network 213, the RF device 201 may be configured to operate with the circular cylindrical antenna 202 in one or more of a RHCP 217, an LHCP 220, a first linear polarization 221, and a second linear polarization 222 different from the first linear polarization. As will be appreciated, the linear polarization type is based upon selection of a pair of feeds (i.e., only two feeds are driven in these polarization states). In some embodiments, portions of the feed network 213 may be omitted if fewer polarizations are needed.

Another aspect is directed to a method for making a circular cylindrical antenna 202 to be coupled to an RF device 201. The method comprises forming a conductive ground plane 203, and positioning a plurality of conductive feeds 204a-204d associated with the conductive ground plane. The method also includes forming a plurality of conductive sinusoidal elements 205a-205d to be coupled to the plurality of conductive feeds and extending outwardly from the conductive ground plane 203 along a circular cylinder 206.

Helpfully, the communications device 200 may be more flexible than prior art approaches, and may operate on multiple polarization modes with a single circular cylindrical antenna 202. Further, as compared to other approaches, for example, as disclosed in U.S. Pat. No. 4,658,262 to Duhamel, the communications device 200 may provide for a greater gain and narrower beamwidth. Regarding the approach of Duhamel, conical and planar shape antenna envelopes were advised only, with sharp pointy elements comprised of alternating concave and convex curve segment. Differently, the present invention uses cylindrical shape antenna envelopes, smooth elements without sharp points, and elements comprising sine shapes.

A relationship may exist between the axial mode helix antenna and the communications device 200. Shining a light through a helix may result in a sine like shape projected on a nearby wall. Projections of a helix on a cylindrical envelope may provide shapes similar to the plurality of conductive sinusoidal elements 205a-205d. Further, the 4 projections of a helix antenna taken in the +X, +Y, −X, −Y directions may be sufficient to synthesize any polarization. In cartesian coordinates, a helix may be defined by:
x(t)=cos(t);
y(t)=sin(t); and
z(t)=t;
where t is parameter of structure growth.
   A cylinder usefully reduces the amount of surface area needed for a given volume making for a space efficiency and small size in the communications device 200.

TABLE 1
provides a nonlimiting description of the
parameters of the circular cylindrical antenna 202:
Exemplary Specifications of the embodiment of FIG. 2A

| Parameter | Description | | Comments |
|---|---|---|---|
| Circular cylindrical | Flexible circuit | | 0.005 inch thick |
| antenna 202 | board wrapped into a | | polyimide substrate |
| construction | cylinder | | |
| Number of conductive | 4 | | |
| circular sinusoidal | | | |
| elements 205a-205d | | | |
| Nominal center | 1550 | MHz | |
| frequency | | | |
| Circular cylinder | 9.45 | centimeters | 0.48λ |
| 206 diameter | | | |
| Circular cylinder | 12.1 | centimeters | 0.63λ |
| 206 height | | | |
| Number of structural | 2.9 | | |
| cycles in each | | | |
| conductive circular | | | |
| sinusoidal element | | | |
| 205a-205d | | | |
| Trace width of each | 0.38 to 0.43 | | |
| of the conductive | centimeters, | | |
| sinusoidal elements | widening at cycle | | |
| 205a-205d | peaks | | |
| Structural period | Approximately 4.2 | | A gap of X = 0.23 |
| 208 of each of the | cycles per | | centimeters existed |
| conductive | centimeter | | between the ground |
| sinusoidal elements | | | plane 203 and the |
| 205a-205d | | | bottom of the |
| | | | flexible circuit |
| | | | board. |
| Structural amplitude | 7.1 | centimeters | 0.37λ (Measured with |
| 209 of each the | | | flexible printed |
| conductive | | | circuit board laid |
| sinusoidal elements | | | out flat) |
| 205a-205d | | | |
| Ground plane 203 | 52 | centimeters | Circular aluminum |
| diameter | | | sheet construction |
| | | | (FIG. 2 showed a |
| | | | smaller diameter |
| | | | ground plane for |
| | | | clarity) |
| Plurality of | Chassis mount SMA | | Conductive circular |
| conductive feeds | connectors | | sinusoidal elements |
| 204a-204d | | | 205a-205d were |
| | | | soldered to SMA |
| | | | connector center |
| | | | pins |
| Excitations of | Equal amplitude | | |
| conductive circular | quadrature phasing, | | |
| sinusoidal elements | 1 └0°, 1 └−90°, | | |
| 205a-205d for right | 1 └−180°, 1 └−270° | | |
| hand circular | successively | | |
| polarization | | | |
| Circuit impedance of | Approximately Z = | | At 1550 MHz |
| circular sinusoidal | 61 + 19j ohms | | |
| elements 205a-205d | | | |
| Impedance matching | None in this | | Direct 50 ohm |
| provisions | instance | | coaxial feed |
| Voltage standing | 1.4 to 1 and under | | At 1550 MHz |
| wave ratio (VSWR) at | | | |
| the plurality of | | | |
| conductive feeds | | | |
| 204a-204d | | | |
| Radiation pattern | Single directive | | Similar to axial |
| | beam firing up the | | mode helix antenna |
| | axis of the circular | | |
| | cylindrical antenna | | |
| | 202 | | |
| Realized gain | 12.6 dBic at | | Decibels with |
| | 1550 MHz | | respect to |
| | | | isotropic, circular |
| | | | polarization. |
| 3 dB gain | 18% | | Increasable somewhat |
| bandwidth | | | with external |
| | | | impedance matching |
| | | | (not shown). |
| 3 dB beamwidth | 42 | degrees | |

| | |
|---|---|
| Sidelobes | 17 dB down from |
| | beam peak. |

Of course, these parameters may be varied to suit particular requirements. The circular cylindrical antenna 202 may be increased in length for more realized gain at narrower beamwidth or reduced in length for less gain and greater beamwidth. The realized gain of the communications device 200 of FIG. 2A, Table 1 embodiment is favorable when compared to the Yagi-Uda antenna. Yagi-Uda antenna design and performance data may be obtained from the paper “Yagi Antenna Design”, Peter P. Viezbicke, NBS Tech Note 688, National Bureau Of Standards (NBS), December 1976. This NBS reference discloses that a 0.63 wavelength tall Yagi Antenna may have a gain of 9.5 dBi. In contrast, a 0.63 wavelength circular cylindrical antenna 202 may provide 12.6 dBic when beamformer losses are not included.

Referring now additionally to FIGS. 5-8, several diagrams 1000, 1010, 1020, & 1030 show performance characteristics for an example embodiment of the communications device 200 (using the characteristics of Table 1). Diagram 1000 shows an elevation cut radiation pattern 1002 in polar coordinates and scaled in units of dBic or decibels with respect to isotropic for circular polarization fields. Polarization sense is righthand circular. The 4 elements of the plurality of conductive sinusoidal elements 205a-205d of the circular cylindrical antenna 202 were fed in phase quadrature with currents of 1 [symbol] 0°, 1 [symbol] −90°, 1 [symbol] −180°, 1 [symbol] −270° value respectively at the plurality of conductive feeds 204a-204d. The dashed trace 1004 was for 1600 MHz, and the solid trace 1006 was for 1600 MHz. Here, a directive single beam radiation pattern is formed along the circular cylindrical antenna 202 axis, which runs up and down the center of the antenna. The peak realized gain is 13.6 dBic, for example. The circular cylindrical antenna 202 is depicted in profile view 1008, which hopefully will assist in understanding orientation of the antenna with respect to the radiation pattern 1002. The beamwidth and the gain are selectively set by changing the length of the circular cylindrical antenna 202 and the number of structural cycles present in the plurality of conductive sinusoidal elements 205a-205d. Realized gains exceeding 20 dBic or more are possible. The circular cylindrical antenna 202 may provide realized gains similar too or perhaps exceeding those of the Yagi-Uda antenna at the same antenna length, and do so at more bandwidth. Back lobe amplitude may be determined by ground plane 203 diameter.

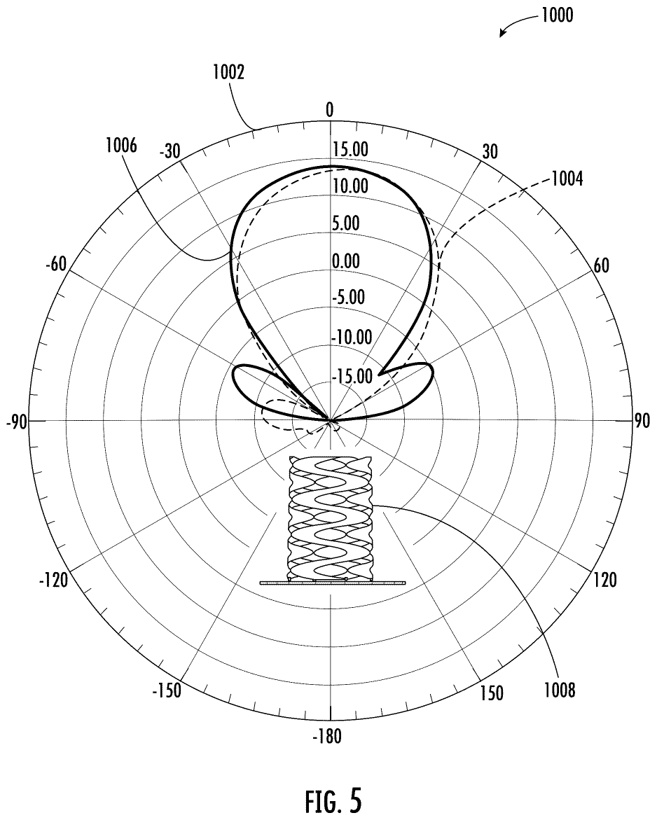

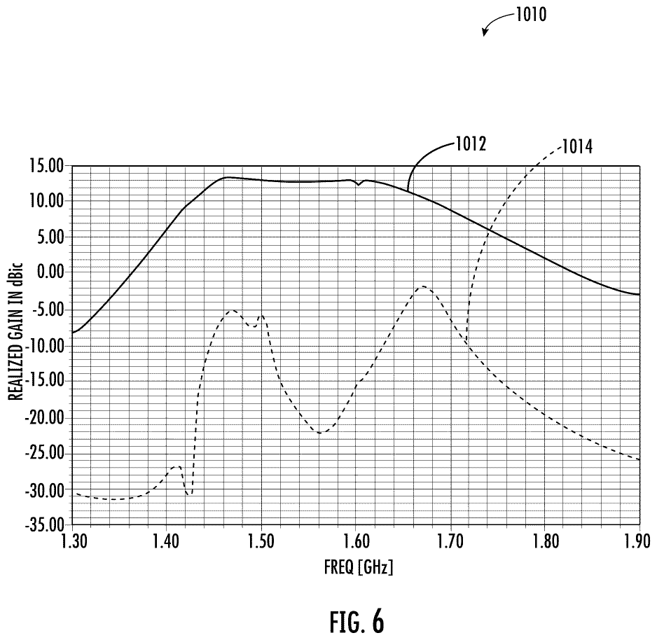

FIG. 6 includes a diagram 1010, which shows a realized gain versus frequency curve for the example embodiment of FIG. 2A using the characteristics of Table 1 for the communications device 200. The solid trace 1012 is right hand circular polarization, and the dashed trace 1014 is for left hand circular polarization, making the diagram 1010 a single circular example. So, the diagram 1010 is for single polarization right hand circular. Possibly, the radiation bandwidth can be increased by external impedance matching (not shown).

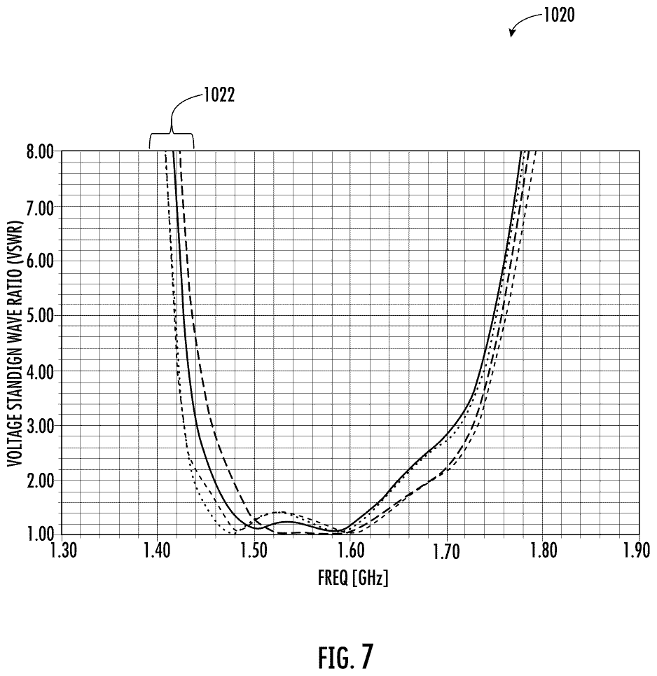

FIG. 7 includes a diagram 1020, which shows a family of 4 voltage standing ratio (VSWR) curves 1022 for the plurality of conductive feeds 204a-204c of the example embodiment of FIG. 2A using the characteristics of Table 1 for the communications device 200. Here, 50-ohm coaxial feeds 204a-204d were used without added impedance matching components. Since the curves 1022 are nearly on top of one individual conductive feeds 204a-204c responses are not called out. As will be appreciated, the VSWR usefully drops under 2 to 1.

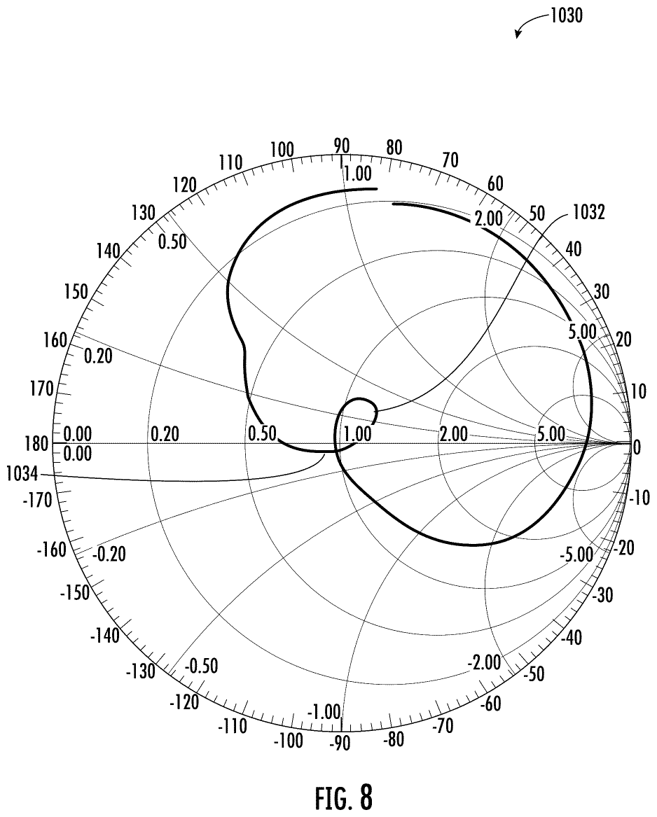

FIG. 8 includes a diagram 1030, which shows a Smith diagram for the example embodiment of FIG. 2A using the characteristics of Table 1 for the communications device 200. The 4 traces are nearly on top of each other so one trace is shown. Diagram 1030 is for the frequency range of 1300 to 1900 MHz. The response loop 1032 is near 1620 MHz and includes a crossover region 1034. The diameter of response loop 1032 may be increased by increasing the structural period 208 of the plurality of conductive sinusoidal elements 205a-205d. Increasing the structural period 208: 1) broadens VSWR bandwidth and; 2) broadens VSWR passband ripple of the circular cylindrical antenna 202. Thus, the example embodiment of FIG. 2A using the characteristics of Table 1 for the communications device 200 is a Chebyshev response or “double tuned” antenna in which passband ripple may be traded for bandwidth as may be familiar from filter theory.

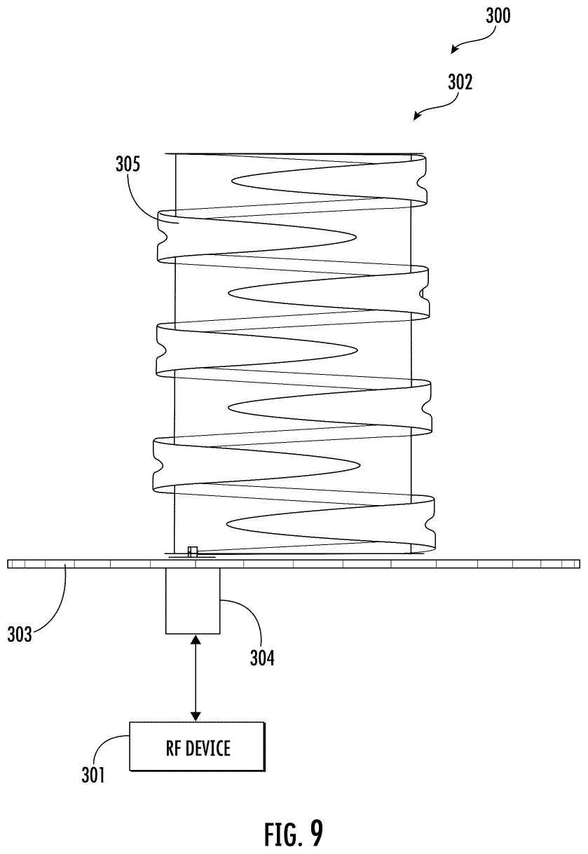

Referring now additionally to FIG. 9, another embodiment of the communications device 300 is now described. In this embodiment of the communications device 300, those elements already discussed above with respect to FIGS. 2A-2D are incremented by 100 and most require no further discussion herein. This embodiment differs from the previous embodiment in that this communications device 300 illustratively includes a single conductive feed 304 and a single conductive sinusoidal element 305. In this embodiment, the single conductive sinusoidal element 305 has an increased structural amplitude 209 characteristic to provide the necessary height in the element to define the circular cylinder.

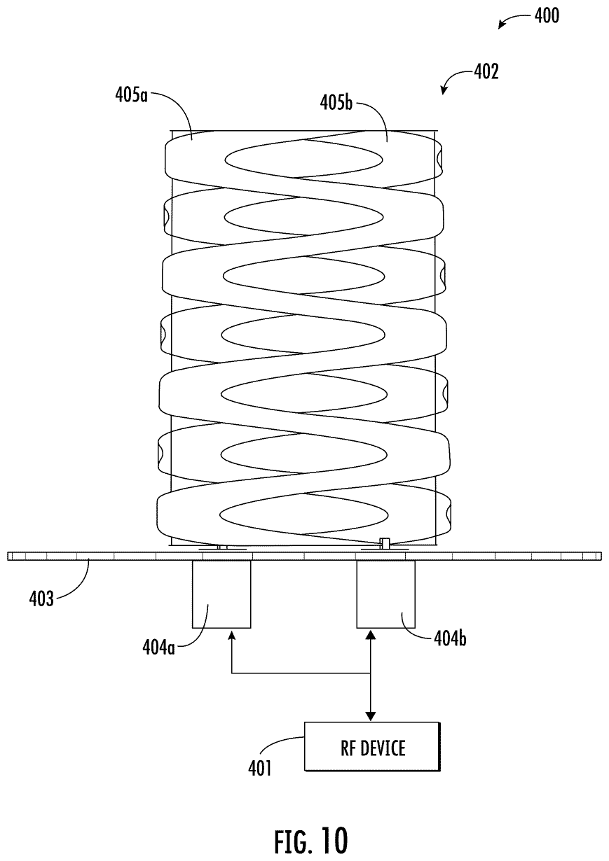

Referring now additionally to FIG. 10, another embodiment of the communications device 400 is now described. In this embodiment of the communications device 400, those elements already discussed above with respect to FIGS. 2A-2D are incremented by 200 and most require no further discussion herein. This embodiment differs from the previous embodiment in that this communications device 400 illustratively includes first and second conductive feeds 404a-404b and first and second conductive sinusoidal elements 405a-405b radially spaced apart by 180° and respectively coupled to the first and second conductive feeds. As will be appreciated, first and second signals fed into the first and second conductive feeds 404a-404b may have a phase spacing of 180°.

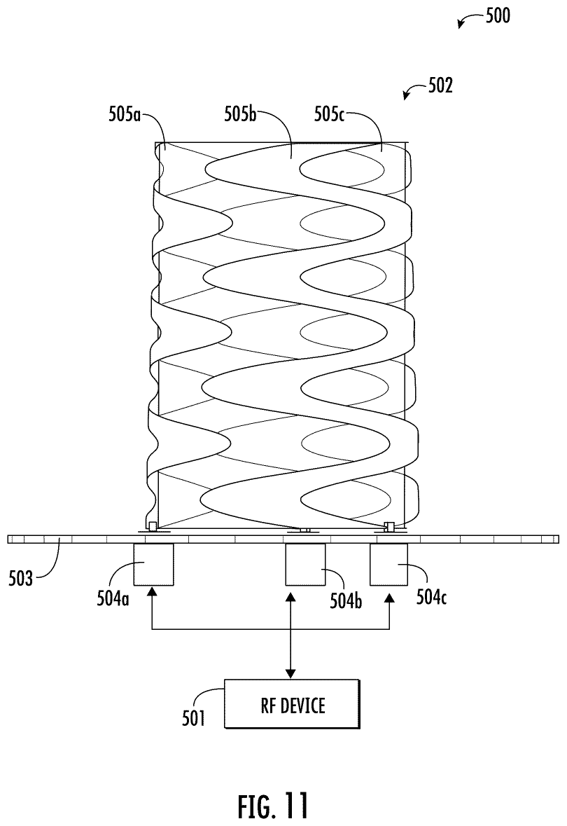

Referring now additionally to FIG. 11, another embodiment of the communications device 500 is now described. In this embodiment of the communications device 500, those elements already discussed above with respect to FIGS. 2A-2D are incremented by 300 and most require no further discussion herein. This embodiment differs from the previous embodiment in that this communications device 500 illustratively includes first, second, and third conductive feeds 504a-504c and first, second, and third conductive sinusoidal elements 505a-505c radially spaced apart by 120° and respectively coupled to the first, second, and third conductive feeds. As will be appreciated, first, second, and third signals fed into the first, second, and third conductive feeds 504a-504c may have a phase spacing of 120°.

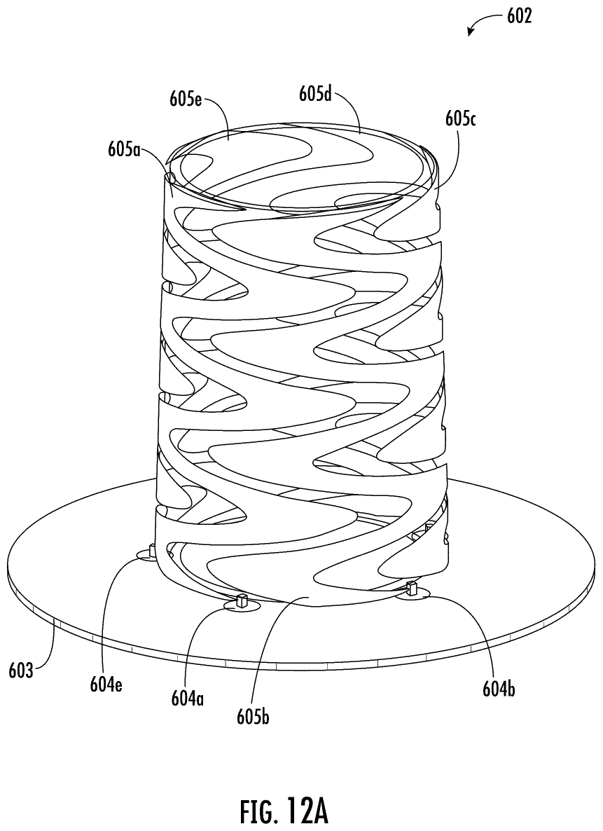

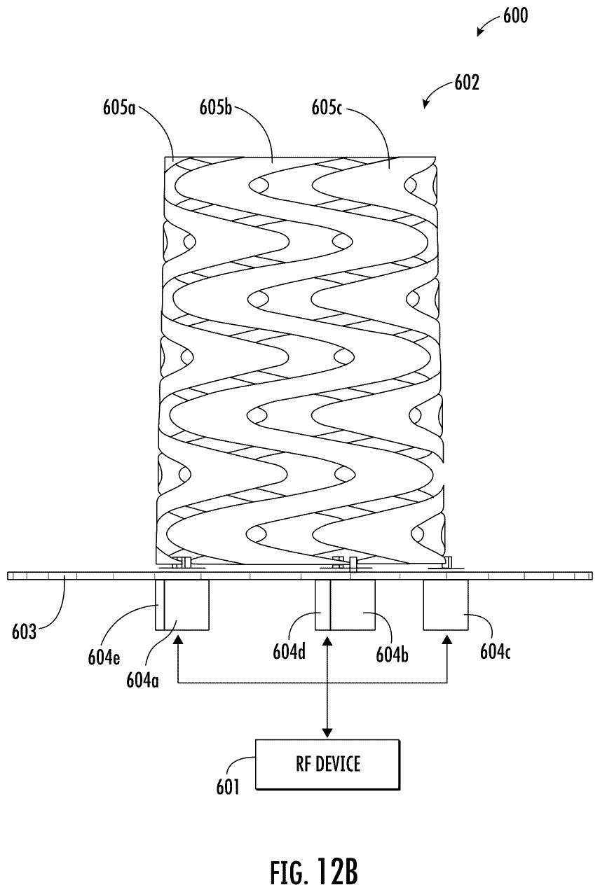

Referring now additionally to FIGS. 12A-12B, another embodiment of the communications device 600 is now described. In this embodiment of the communications device 600, those elements already discussed above with respect to FIGS. 2A-2D are incremented by 400 and most require no further discussion herein. This embodiment differs from the previous embodiment in that this communications device 600 illustratively includes first, second, third, fourth, and fifth conductive feeds 604a-604e and first, second, third, fourth, and fifth conductive sinusoidal elements 605a-605e radially spaced apart by 72° and respectively coupled to the first, second, third, fourth, and fifth conductive feeds. As will be appreciated, first, second, third, fourth, and fifth signals fed into the first, second, third, fourth, and fifth conductive feeds 604a-604e may have a phase spacing of 72°.

Unlike the prior art axial mode helix antenna, in the present embodiments, the sense of polarization is determined by the mode and sense of excitation rather than being enforced in only one way by antenna structure. Thus, many options exist as to the number of sinusoidal elements 605a-605e. Table 2 provides a partial list:

TABLE 2
Partial List of Configurations and Polarizations

| | Structural location | | |
|---|---|---|---|
| Number of | of conductive | | |
| conductive | sinusoidal elements | | |
| sinusoidal | 205a-205d about | | |
| elements | circular cylinder | Excitations At | |
| 205a-205d | 206, e.g., clocking | Conductive Feeds 204 | Polarization |
| 1 | Any | 1 └0° | Single |
| | | | channel |
| | | | linear |
| 2 | 0°, 180° | 1 └0°, 1 └180° | Single |
| | | | channel |
| | | | linear |
| 3 | 0°, 120°, 240° | 1 └0°, 1 └−120°, | Single |
| | | 1 └−240° | channel right |
| | | | hand circular |
| 4 | 0°, 90°, 180°, | 1 └0°, 1 └−90°, | Single |
| | 270° | 1 └−180°, 1 └270° | channel right |
| | | | hand circular |
| 5 | 0°, 72°, 144°, | 1 └0°, 1 └72°, | Single |
| | 216°, 288° | 1 └144°, 1 └216°, | channel right |
| | | 1 └288° | hand circular |
| 4 | 0°, 90°, 180°, | Linear polarization | Dual linear |
| | 270° | channel 1: 0° and | |
| | | 180° drive to | |
| | | elements clocked 0° | |
| | | and 180°. Cross | |
| | | linear polarization | |
| | | channel 2: 0° and | |
| | | 180° drive to | |
| | | elements clocked 90° | |
| | | and 270°. | |

It is possible to use more than 5 conductive sinusoidal elements 205a-205d for increased directivity and gain with a large diameter circular cylinder 206, for polarization, of for radiation pattern synthesis. Only single polarizations are described in Table 2. Dual circular polarizations may be accomplished with an external quadrature hybrid power divider(s) to divide the RF power to the conductive sinusoidal elements. Quadrature hybrid power dividers internally circulate traveling wave energies useful to synthesize circular polarization and sort the left and right hand polarization senses. Delay lines may also be used to synthesize circular polarization from a radial or corporate RF power divider.

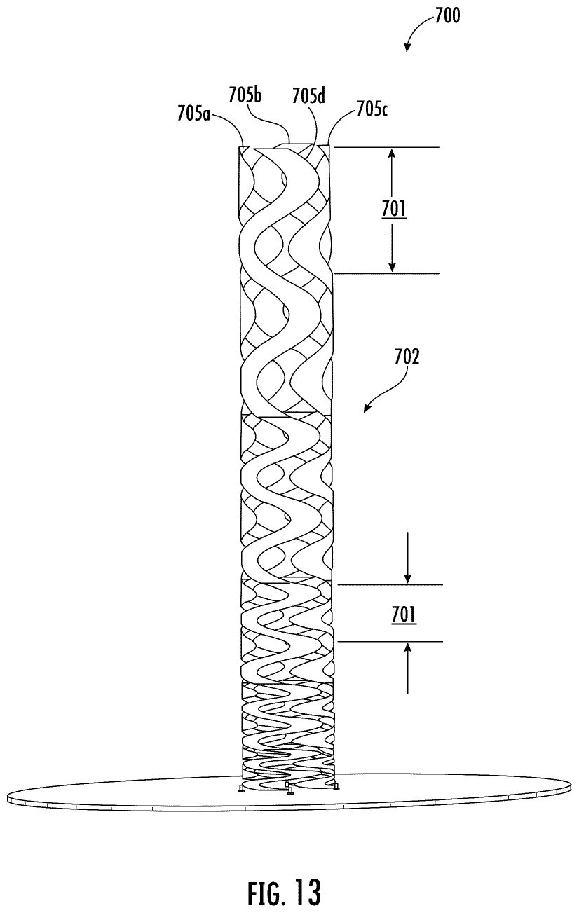

Referring now additionally to FIG. 13, another embodiment of the communications device 700 is now described. The communications device 700 illustratively includes a varying structural period 701 embodiment cylindrical antenna 702. There are more structural cycles per axial length of the antenna 702 at the bottom and fewer structural cycles per axial length at the top or radiating end of the antenna 702. This varying rate of structural period 701 increases gain and reduce sidelobes in taller cylindrical antennas 702. The varying rate of structural period 701 in the sinusoidal elements 705a-705d varies the propagation velocity of the electromagnetic energies along the length of the antenna 702, those energies being the electric fields E, magnetic fields H, and electric currents I. In a tall cylindrical antenna 702, the E and H fields may vary in speed from about ⅓ the speed of light (0.33c) at the proximal end to nearly the speed of light say (0.9c) at the top radiating end. Cylindrical antenna 702 is slow wave, traveling wave and surface wave device as the cylindrical antenna 702: 1) transduces the developing radio wave fields from electric currents I; 2) captures and conveys the developing radio wave fields axially along the cylindrical antenna 702 structure and; 3) expands and releases the E and H fields smoothly at the radiating end to synthesize an aperture.

The varying structural period 701 controls the axial velocity of the electric currents I relative the axial velocity of the electric fields E and magnetic fields H. To advance axially, the electric currents have to move back and forth over a path longer than the E and H fields have to take. Further, varying structural period 701 may benefit adjustment of driving impedance z=r+jx. A slow varying structural period 701 at the start may reduce driving resistance r, and a fast varying structural period 701 at the start may increase driving resistance r. Constant structural period sinusoidal elements 705a-705d may have sidelobes of near 13 dB down from the main, on axis lobe. Varying structural period 701 sinusoidal elements 705a-705d may have sidelobes 17 to 22 dB down from the main lobe. Radiation predominately occurs from the distal end and not from lower regions of the cylindrical antenna 702 when well adjusted. Phase dispersion and group delay are minimized by holding the forming radio wave to the cylindrical antenna 702 structure until the antenna radiating end is reached.

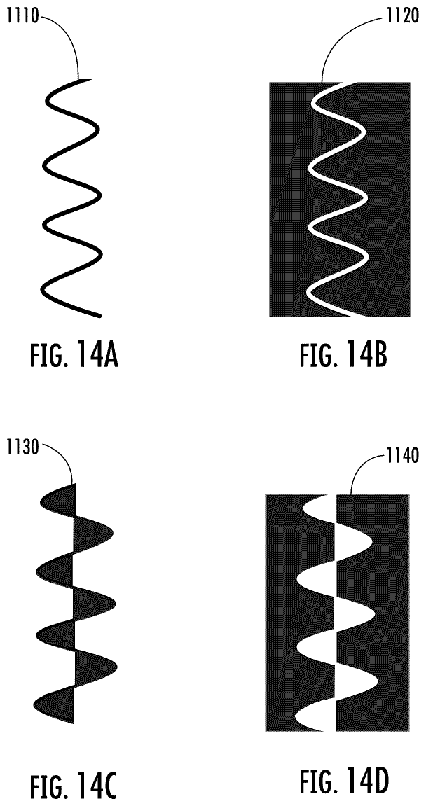

Referring to FIGS. 14A-14D, additional embodiments of the communications device 200 of FIG. 2A are shown. In this diagram, the color black denotes an electrical conductor material, such as metal, and the color white denotes electrical insulator material, such as vacuum, air or plastic. For drawing clarity purposes only, one conductive sinusoidal element is shown, and it is understood that any number of conductive sinusoidal elements may be provided on the antenna cylindrical envelope. A conductive sinusoidal element 1110 has been described previously and is shown for reference. The conductive sinusoidal element 1120 may be considered a skeletal embodiment. Differently, in conductive sinusoidal element 1120, the area around the sinusoidal element(s) is electrically conductive and the conductive sinusoidal elements are air or an insulator material. So, the insulator and the conductor are reversed. In the conductive sinusoidal element 1130, the area under the conductive sinusoidal element is made electrically conductive. The conductive sinusoidal element 1140 depicts an embodiment in which the sinusoidal elements are air or insulative material in a metal conductive surroundings, as may benefit structural needs.

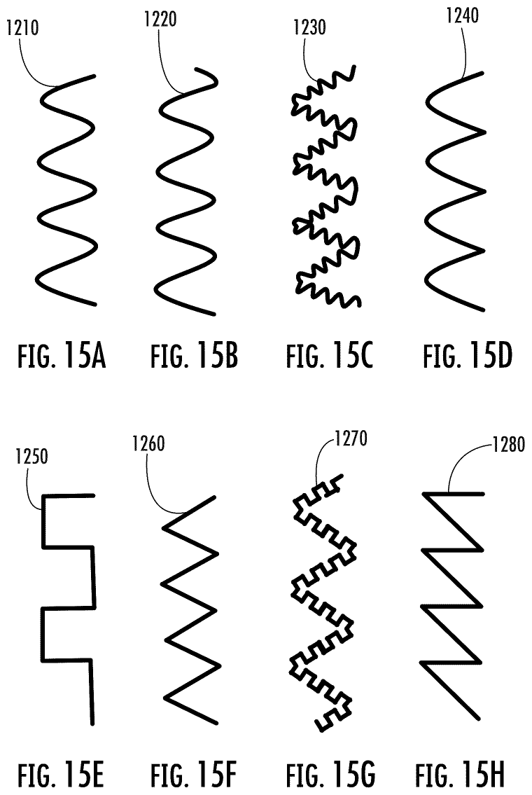

While sinusoidal shape conductive elements have been discussed thus far it is understood that approximation shapes may be used for the conductive elements. Referring to the FIGS. 15A-15H, polygonal and fractal embodiments of the elements used in the communications device 200 are now shown. Electrical conductors of FIGS. 15A-15H are shown in black. The conductive element 1210 shows a sine shape conductive element as described previously for reference. The conductive elements 1220 is a sine shape conductive element shifted in the start of electrical phase by shifting structural position as may benefit polarization synthesis or impedance matching. The conductive elements 1230 depicts a fractal sine wave conductive element comprising many small reversal in direction or subcycles, which may benefit tuning or miniaturization. The conductive element 1240 depicts a half cycle or rectified wave series conductive element, which may benefit pattern shaping. The conductive element 1250 depicts a square wave conductive element, which advances in discrete steps as may benefit manufacture or size reduction. The conductive element 1260 is a triangular or sawtooth waveform conductive element, which may be simpler to manufacture. The conductive element 1270 depicts a fractal or linearly loaded conductive element, which may reduce size. Indeed, the conductive element 205a-205d may be approximated by polygons or a polygonal mesh. For example, the conductive element 1280 depicts a sinusoidal conductive element 205a-205d.

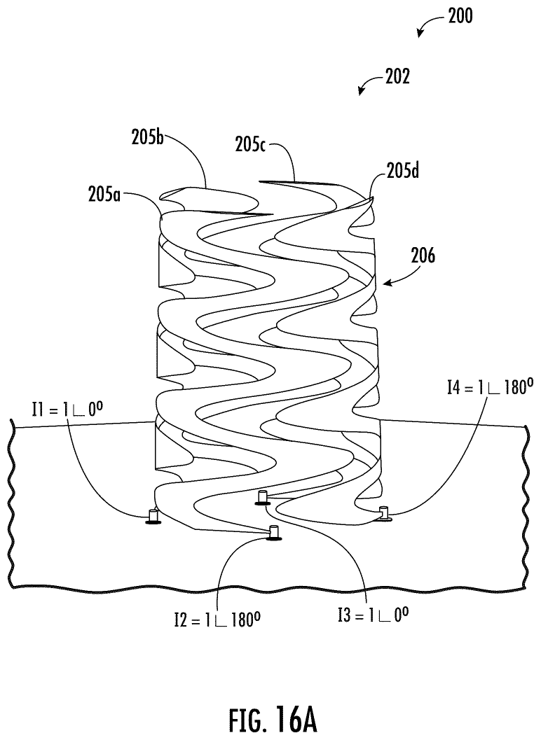

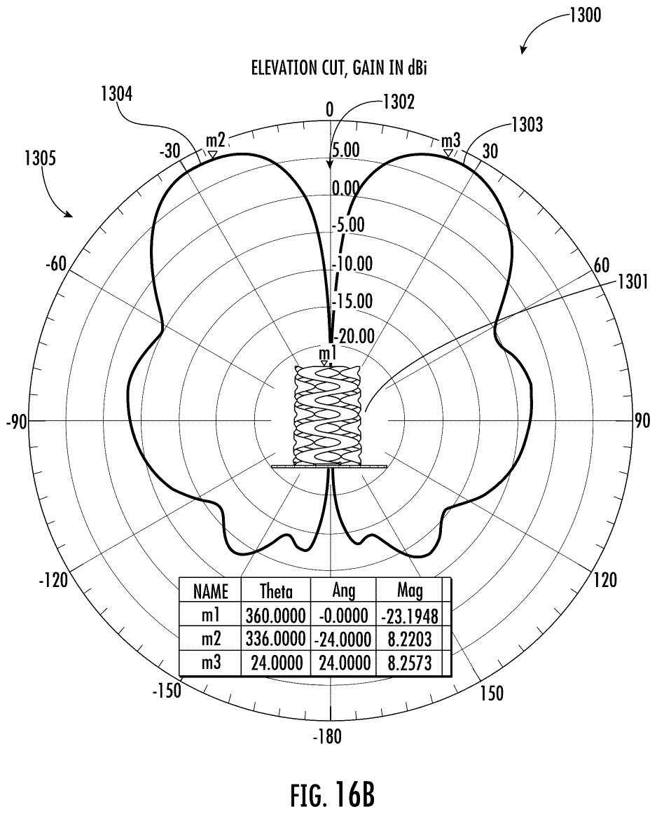

Referring now additionally to FIG. 16A, the embodiment of the communications device 200 from FIGS. 2A-2D is now described with a different radiation pattern shape having an axial null. Here, unlike before in FIGS. 2A-2D, they are provided with electrical excitations of I=1 [symbol] 0°, I=1 [symbol] 180°, I=1 [symbol] 0°, and I=1 [symbol] 180° sequentially around the cylindrical antenna envelope. Therefore, the total electrical excitation phase advance around the circular cylinder 206 is now 2(360°)=720°. FIG. 16B includes a diagram 1300 showing a radiation pattern that plots the gain of the embodiment of FIG. 16A circular cylindrical antenna as a function of elevation angle θ. Feature 1301 is a profile view of the circular cylindrical antenna for orientation. A deep skirted radiation pattern null 1302 is seen along the axis of the circular cylinder and radiation pattern lobes 1303, 1304 occur approximately +−25° off the axis of the circular cylindrical antenna. In three-dimensional viewing, a conical radiation pattern is formed. A diagram 1305 radiation pattern may aid direction finding, tracking or monopulse as a small signal source movement off the circular cylindrical antenna axis produces a large signal change. More than n=4 conductive circular sinusoidal elements may be used to form an axial null embodiment (FIGS. 16A-16B) and again the excitation phasing occurs at twice the angular rate of the axial lobe embodiment of FIGS. 2A-2D. For example, a circular cylindrical antenna having n=8 conductive circular sinusoidal elements (not shown) would have successive excitations of 1 [symbol] 0°, 1 [symbol] 90°, 1 [symbol] 180°, 1 [symbol] 270°, 1 [symbol] 360°, 1 [symbol] 450°, 1 [symbol] 540°, 1 [symbol] 630°, and if the modulus of 360° is subtracted, 1 [symbol] 0°, 1 [symbol] 90°, 1 [symbol] 180°, 1 [symbol] 270°, 1 [symbol] 0°, 1 [symbol] 90°, 1 [symbol] 180°, 1 [symbol] 270°. Increasing numbers of conductive circular sinusoidal elements will reduce axial ratio and improve the quality of circular polarization.

The diameter of the circular cylindrical antenna in the radiation pattern FIB. 16B was 0.4 wavelengths; however, the range of circular antenna diameters may range from 0.1 wavelengths to 10 or more wavelengths depending on the number of circular sinusoidal elements and the desired compaction. The prior art axial mode helix antenna may not provide an axial null radiation pattern in the size and manner that the circular cylindrical antenna does. Hopefully, the present disclosure wave antenna may provide a replacement for the common art axial mode helix antenna when needs of dual polarization, linear polarization, axial lobe radiation patterns, axial null radiation patterns and higher realized gains are required.

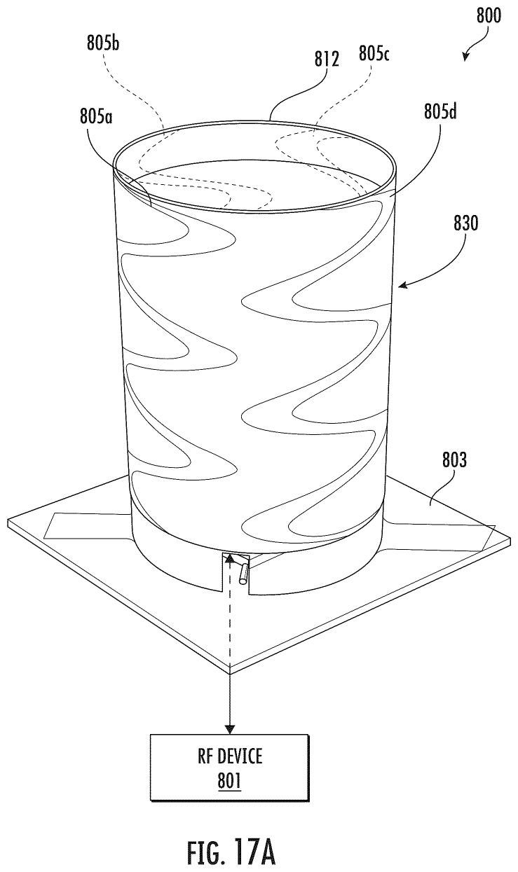

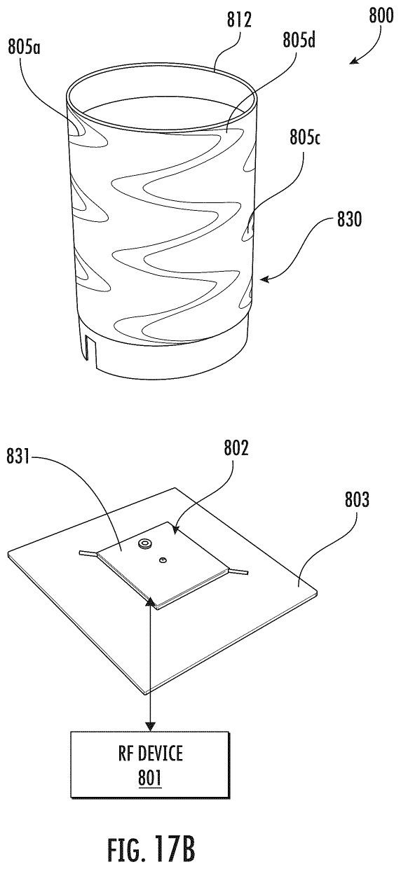

Referring now to FIGS. 17A-17B, another embodiment of the communications device 800 is now described. In this embodiment of the communications device 800, the circular cylindrical antenna 202 from the embodiments of FIGS. 2A-2D is reconfigured as an RF lens. Here, those elements already discussed above with respect to the embodiments of FIGS. 2A-2D are incremented by 600 and most require no further discussion herein.

This communications device 800 illustratively includes an RF device 801 (e.g., an RF transceiver), an RF antenna 802 coupled to the RF device, and an RF lens 830 adjacent to the RF antenna. As will be appreciated, the RF lens 830 is electrically insulated from the RF device 801 and bends/focuses an RF signal (transmit/receive). The RF lens 830 comprises a dielectric substrate 812, and a plurality of conductive sinusoidal traces 805a-805d carried by the dielectric substrate.

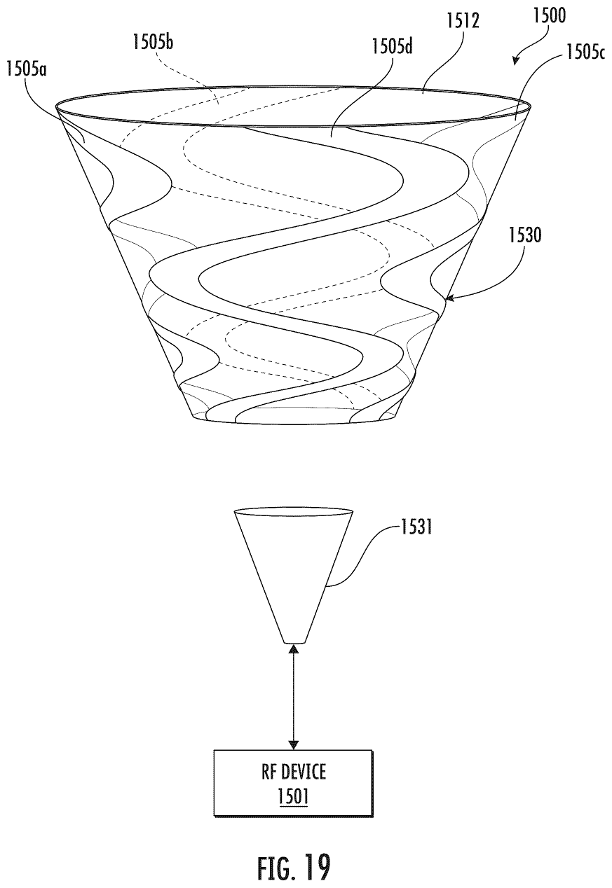

The plurality of conductive sinusoidal traces 805a-805d illustratively includes conductive sinusoidal traces equally-sized and arranged about the dielectric substrate 812. Also, adjacent ones of the plurality of conductive sinusoidal traces 805a-805d are illustratively nested together. As will be appreciated, for example, as disclosed in the above embodiments, the number, the spacing, the frequency, and the amplitude of the plurality of conductive sinusoidal traces 805a-805d may be varied for the RF lens 830. In the illustrated embodiment, the dielectric substrate 812 has a cylinder-shape. Of course, the dielectric substrate 812 may take on other shapes in other embodiments, such as described with respect to FIG. 19.

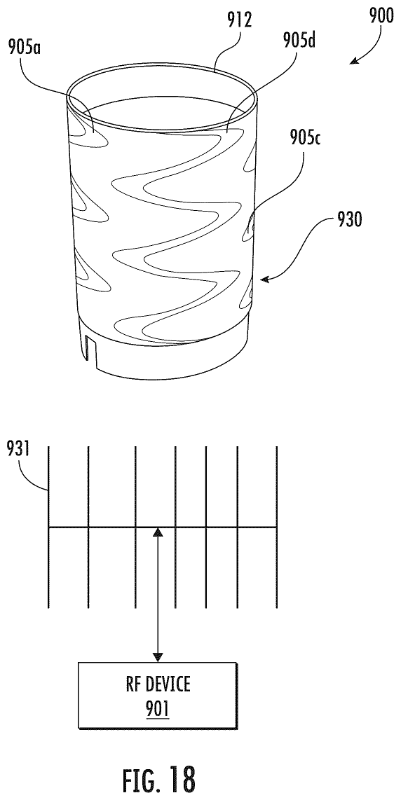

The RF antenna 802 illustratively comprises a patch antenna element 831, and a conductive ground plane 803. Of course, the conductive ground plane 803 may be omitted in some embodiments. Further, the RF antenna 802 may be exchanged for other antenna form factors, such as shown in FIGS. 18-22. The patch antenna element 831 supplies waves to the RF lens 830, and the RF antenna 802 need only be proximal to the RF lens. In FIG. 17A, the RF lens 830 faithfully reproduces without change whatever polarization that patch antenna element 831 supplies.

For example, each of the conductive ground plane 803 and the plurality of conductive sinusoidal traces 805a-805d may comprise one or more of copper, aluminum, silver, and gold, for example. It is understood that the conductive sinusoidal traces 805a-805d could also constitute conductive cosine traces, or sinusoidal elements shifted in phase structurally to start at any point in the structures cyclic motion.

With regards to spatial dimensions of the RF lens 830 and the RF antenna 802, these are defined by an operating wavelength of the communications device 800. For example, the dielectric substrate 812 may have a diameter between 0.3 and 0.5 of the operating wavelength, and the dielectric substrate may have a height between 0.5 and 1 of the operating wavelength. Each of the plurality of conductive sinusoidal traces 805a-805d may define a wave period between 0.1 and 0.3 of the operating wavelength. Further, a quantity and orientation of the plurality of conductive sinusoidal traces 805a-805d may provide a wave polarizer function.

In one example embodiment, the spatial dimensions of the RF lens 830 are provided in Table 3.

TABLE 3
Sinusoidal Lens Antenna Parameters

| Aspect | Value | | Notes |
|---|---|---|---|
| Nominal center | 1600 | MHz | |
| frequency | | | |
| Realized gain, patch | 9 | dBi | |
| antenna element 831 | | | |
| alone | | | |
| Realized gain, patch | 15 | dBi | |
| antenna element 831 | | | |
| in combination with | | | |
| RF lens 830 | | | |
| RF lens 830 cylinder | 29.7 | cm | 1.50λ |
| circumference | | | |
| RF lens 830 cylinder | 12.1 | cm | 0.63λ |
| height | | | |
| Number of elements n | 4 | | |
| Number of cycles in | 2.9 | | Number of |
| each sinusoidal | | | “zig zags”. |
| element | | | |
| Sinusoidal element | Varying 0.38 | | Widest at |
| trace width | to 0.43 cm | | peaks. |
| Sinusoidal element | 4.2 cm per 1 | | 0.22λ |
| structural period | cycle | | |
| Sinusoidal element | 7.1 | cm | 0.37λ |

| | | |
|---|---|---|
| structural amplitude | | |
| Connector type | None used on | Incident |
| | lens | wave |
| | | excitation |

Each of the plurality of conductive sinusoidal traces 805a-805d has a shape defined by a sine function. It should be appreciated that the shape of the conductive sinusoidal traces 805a-805d may comprise a sine function like shape (i.e., deviating from an exact sine function shape). In some embodiments, the sine function may comprise (d/4)sin(2πf)+0.8(d/4)sin(2πf). Where f is an operating frequency of the RF antenna 802, and where d is a diameter of the dielectric substrate 812. In other words, the amplitude of the plurality of conductive sinusoidal traces 805a-805d is directly related to the operating frequency. The height (i.e., the thickness across the surface of the dielectric substrate 812) of each of the amplitude of the plurality of conductive sinusoidal traces 805a-805d is defined the sine function noted hereinabove. In some embodiments, the height may be near zero, and provide wire-like conductive sinusoidal traces 805a-805d; therefore, the illustrated embodiment may comprise four sinusoidal wire extending upwards from the conductive ground plane 803.

Another aspect is directed to a method for making a communications device 800. The method comprises coupling an RF antenna 802 to an RF device 801, and positioning an RF lens 830 adjacent to the RF antenna. The RF lens 830 comprises a dielectric substrate 812, and a plurality of conductive sinusoidal traces 805a-805d carried by the dielectric substrate.

Referring now additionally to FIG. 18, another embodiment of the communications device 900 is now described. In this embodiment of the communications device 900, those elements already discussed above with respect to FIGS. 17A-17B are incremented by 100 and most require no further discussion herein. This embodiment differs from the previous embodiment in that this communications device 900 illustratively includes an RF antenna 902 comprising a Yagi-Uda antenna element 931.

Referring now additionally to FIG. 19, another embodiment of the communications device 1500 is now described. In this embodiment of the communications device 1500, those elements already discussed above with respect to FIGS. 17A-17B are incremented by 700 and most require no further discussion herein. This embodiment differs from the previous embodiment in that this communications device 1500 illustratively includes an RF antenna 1502 comprising a horn antenna element 1531. Further, the dielectric substrate 1512 has a cone-shape rather than the cylinder shape of the prior embodiments of FIGS. 17A-17B & 18.

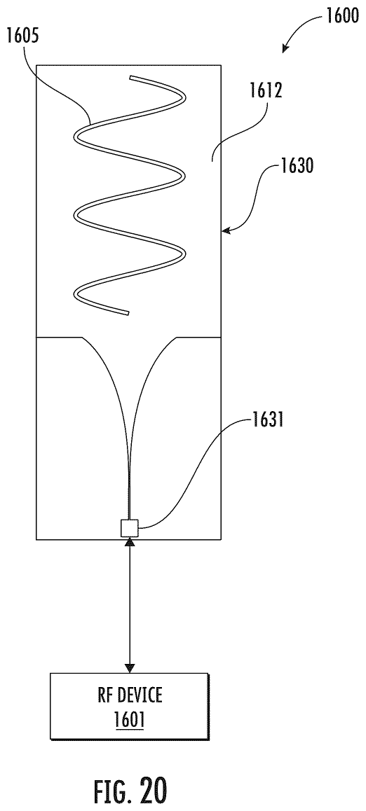

Referring now additionally to FIG. 20, another embodiment of the communications device 1600 is now described. In this embodiment of the communications device 1600, those elements already discussed above with respect to FIGS. 17A-17B are incremented by 800 and most require no further discussion herein. This embodiment differs from the previous embodiment in that this communications device 1600 illustratively includes a single conductive sinusoidal trace 1605 on a planar dielectric substrate 1612. Further, this communications device 1600 illustratively comprises a Vivaldi antenna element 1631, and provides a unidirectional beam with increased gain.

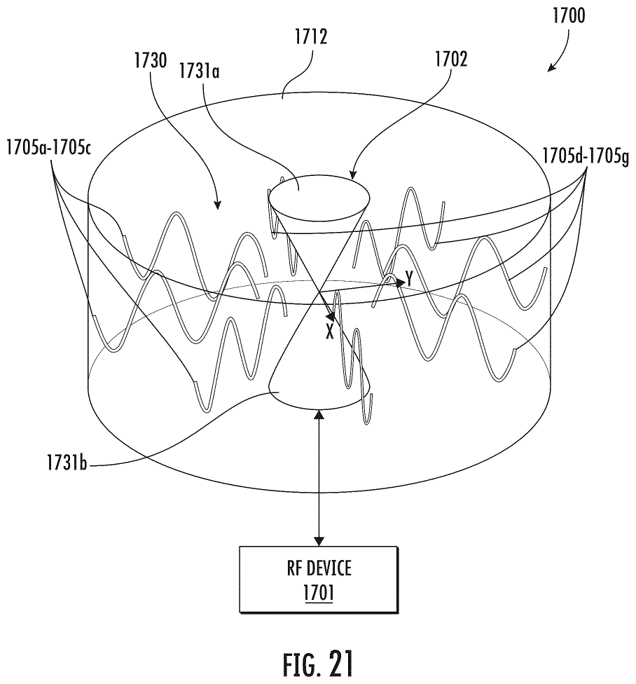

Referring now additionally to FIG. 21, another embodiment of the communications device 1700 is now described. In this embodiment of the communications device 1700, those elements already discussed above with respect to FIGS. 17A-17B are incremented by 900 and most require no further discussion herein. This embodiment differs from the previous embodiment in that this communications device 1700 has a radial lens form factor. Here, the communications device 1700 illustratively includes plurality of conductive sinusoidal traces 1705a-1705g radially oriented about a medial plane, and a dielectric substrate 1712 illustratively comprising a dielectric cylinder (e.g., dielectric foam cylinder). Further, this communications device 1700 illustratively comprises first and second horn antenna elements 1731a-1731b firing in opposite directions, being bisected by the medial plane. Further, this communications device 1700 may provide an omnidirectional beam with increased gain about the horizon.

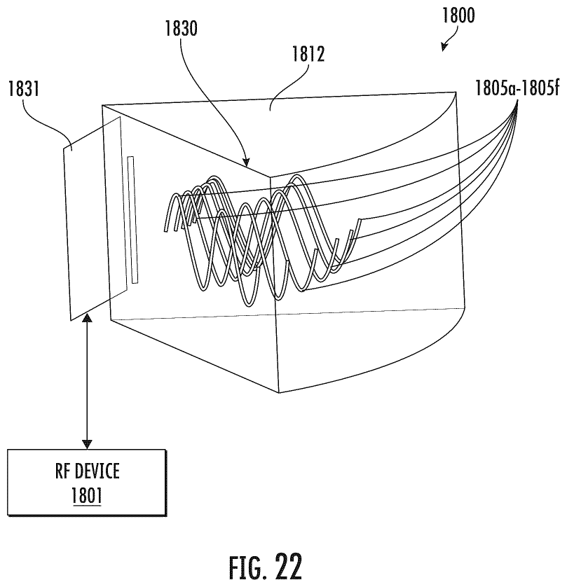

Referring now additionally to FIG. 22, another embodiment of the communications device 1800 is now described. In this embodiment of the communications device 1800, those elements already discussed above with respect to FIGS. 18A-18B are incremented by 1000 and most require no further discussion herein. This embodiment differs from the previous embodiment in that this communications device 1800 has a radial sectoral lens form factor. Here, the communications device 1800 illustratively includes a plurality of conductive sinusoidal traces 1805a-1805f radially oriented within a sector, and a dielectric substrate 1812 illustratively comprising a sector of a dielectric cylinder. Further, this communications device 1800 illustratively comprises a patch antenna element 1831. Further, this communications device 1800 may provide a sectoral or wedge-shaped beam, which may be helpful in radio tower applications.

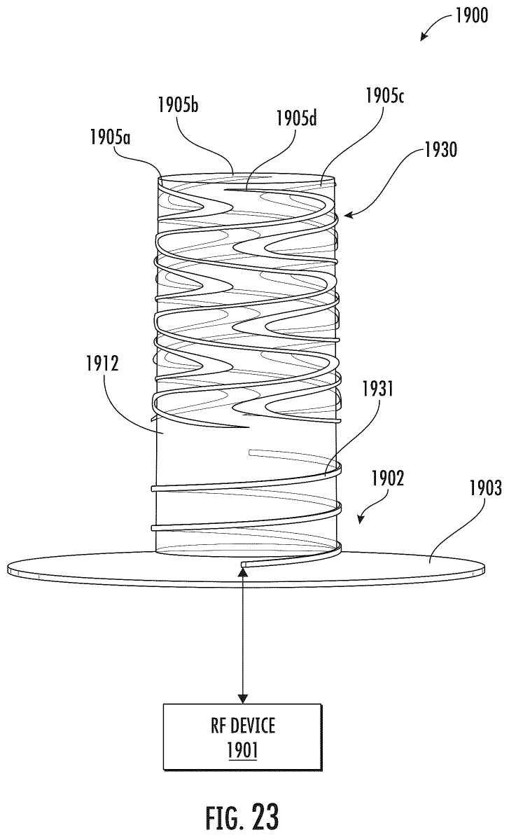

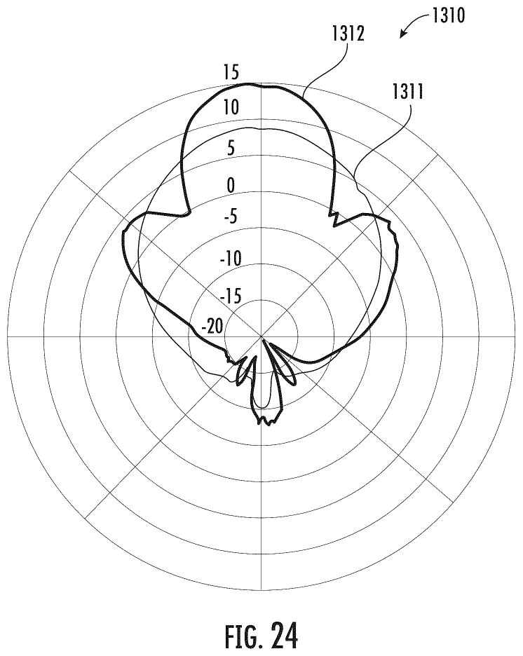

Referring now additionally to FIG. 23, another embodiment of the communications device 1900 is now described. In this embodiment of the communications device 1900, those elements already discussed above with respect to FIGS. 17A-17B are incremented by 1100 and most require no further discussion herein. This embodiment differs from the previous embodiment in that this communications device 1900 illustratively comprises a helix-type antenna element 1931. Further, this communications device 1900 may provide more directionality than a typical helix antenna of the same length.

Referring to FIG. 24, a diagram 1310 shows performance for the communications device 800 of FIGS. 17A-17B. Diagram 1310 shows the shape of the radiation pattern for the communications device 800. Line 1311 shows the pattern without the RF lens 830, and line 1312 shows the pattern with the RF lens. As shown, the use of the RF lens 830 may provide a gain increase of 6 dB with 4 times more signal strength.

Advantageously, the disclosed communications devices 800, 900, 1500, 1600, 1700, 1800, 1900 provide an antenna design including an RF lens with high realized gain for size. In typical designs, RF lenses, such as convex dielectric lenses and parabolic reflectors, are used. These existing lenses may be costly, heavy, and bulky, making them less desirable in applications with demanding size weight and power requirements (SWaP) (e.g., satellite devices). In particular, convex dielectric lenses may suffer from: heavy weight, large size, costly material costs, lossy performance, dispersion of signals in time and frequency, and poor performance under 20 GHZ. Parabolic reflectors may suffer from: lossy performance, unwanted back reflections, feed spillover, surface accuracy demands, and poor performance under 2 GHZ.

The communications devices 800, 900, 1500, 1600, 1700, 1800, 1900 may replace metal parabolas and dielectric lenses for lower frequency applications and lightweight applications. Further, the communications devices 800, 900, 1500, 1600, 1700, 1800, 1900 can shape radiation patterns into columnated beams for reflector antennas. The communications devices 800, 900, 1500, 1600, 1700, 1800, 1900 also may not suffer from back reflections, as in typical parabolic reflectors, and this antenna design may have a VSWR under 2:1. The communications devices 800, 900, 1500, 1600, 1700, 1800, 1900 may be less costly to manufacture, and can be fabricated using printed wired board manufacturing techniques. The communications devices 800, 900, 1500, 1600, 1700, 1800, 1900 may have improved SWaP characteristics, and this design may be versatile in accepting a wide range of polarizations (e.g., linear polarization, circular polarization) for a signal feed.

It should be appreciated that any of the features from the circular cylindrical antennas 202, 302, 402, 502, 602, 702 may be combined with the RF lenses 830, 930, 1530, 1630, 1730, 1830, 1930 disclosed herein.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A communications device comprising:
a radio frequency (RF) device;
an RF antenna coupled to the RF device; and
an RF lens adjacent to the RF antenna and comprising a dielectric substrate, and at least one conductive sinusoidal trace carried by the dielectric substrate.

2. The communications device of claim 1 wherein the at least one conductive sinusoidal trace comprises a plurality of conductive sinusoidal traces.

3. The communications device of claim 2 wherein the plurality of conductive sinusoidal traces comprises four conductive sinusoidal traces equally-sized and arranged about the dielectric substrate.

4. The communications device of claim 2 wherein adjacent ones of the plurality of conductive sinusoidal traces are nested together.

5. The communications device of claim 1 wherein the dielectric substrate has a cylinder-shape.

6. The communications device of claim 1 wherein the dielectric substrate has a cone-shape.

7. The communications device of claim 1 wherein the RF antenna comprises one of a patch antenna, a horn antenna, and a Yagi-Uda antenna.

8. The communications device of claim 1 wherein the RF antenna has an operating wavelength; wherein the dielectric substrate has a diameter between 0.3 and 0.5 of the operating wavelength; wherein the dielectric substrate has a height between 0.5 and 1 of the operating wavelength; and wherein the at least one conductive sinusoidal trace defines a wave period between 0.1 and 0.3 of the operating wavelength.

9. The communications device of claim 1 wherein the at least one conductive sinusoidal trace has a shape based upon (d/4)sin(2πf)+0.8(d/4)sin(2πf); wherein f is an operating frequency of the RF antenna; and wherein d is a diameter of the dielectric substrate.

10. The communications device of claim 1 wherein the at least one conductive sinusoidal trace provides a wave polarizer function.

11. A communications device comprising:
a radio frequency (RF) antenna to be coupled to an RF device; and
an RF lens adjacent to the RF antenna and comprising a dielectric substrate, and at least one conductive sinusoidal trace carried by the dielectric substrate.

12. The communications device of claim 11 wherein the at least one conductive sinusoidal trace comprises a plurality of conductive sinusoidal traces; wherein adjacent ones of the plurality of conductive sinusoidal traces are nested together; and wherein the plurality of conductive sinusoidal traces comprises four conductive sinusoidal traces arranged about the dielectric substrate.

13. The communications device of claim 11 wherein the dielectric substrate has a cylinder-shape.

14. The communications device of claim 11 wherein the dielectric substrate has a cone-shape.

15. The communications device of claim 11 wherein the RF antenna comprises one of a patch antenna, a horn antenna, and a Yagi-Uda antenna.

16. The communications device of claim 11 wherein the RF antenna has an operating wavelength; wherein the dielectric substrate has a diameter between 0.3 and 0.5 of the operating wavelength; wherein the dielectric substrate has a height between 0.5 and 1 of the operating wavelength; and wherein the at least one conductive sinusoidal trace defines a wave period between 0.1 and 0.3 of the operating wavelength.

17. The communications device of claim 11 wherein the at least one conductive sinusoidal trace has a shape based upon (d/4)sin(2πf)+0.8(d/4)sin(2πf); wherein f is an operating frequency of the RF antenna; and wherein d is a diameter of the dielectric substrate.

18. A method for making a communications device, the method comprising:
coupling a radio frequency (RF) antenna to an RF device; and
positioning an RF lens adjacent to the RF antenna, the RF lens comprising a dielectric substrate, and at least one conductive sinusoidal trace carried by the dielectric substrate.

19. The method of claim 18 wherein the at least one conductive sinusoidal trace comprises a plurality of conductive sinusoidal traces.

20. The method of claim 19 wherein the plurality of conductive sinusoidal traces comprises four conductive sinusoidal traces equally-sized and arranged about the dielectric substrate.

21. The method of claim 19 wherein adjacent ones of the plurality of conductive sinusoidal traces are nested together.

22. The method of claim 18 wherein the dielectric substrate has one of a cylinder-shape and a cone-shape.

23. The method of claim 18 wherein the RF antenna comprises one of a patch antenna, a horn antenna, and a Yagi-Uda antenna.
